(19) United States
(12) Patent Application Publication
(10) Pub. No.: US 2005/0190706 A1
(43) Pub. Date: Sep. 1, 2005

(54) Automatic conferencing service

(76) Inventors: Eric Alan Henderson, San Jose, CA (US); Abdessattar Sassi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/787,328

(22) Filed: Feb. 26, 2004

(51) Int. Cl. H04L 12/16

(52) U.S. Cl. 370/260

(57) ABSTRACT

One embodiment disclosed relates to an apparatus for an automatic conferencing service. The apparatus includes at least a service logic execution environment in a telecommunications service network, and an automatic conferencing service running in the service logic execution environment. Another embodiment disclosed relates to a method of scheduling an automatic conference. A conference request, including conference information specified by a user, is received by an automatic conferencing service running in a service logic execution environment within a telecommunications network. The automatic conferencing service registers the conference and sends notification to attendees of the conference.

### BACKGROUND OF THE INVENTION

1. Field of the Invention

The present invention relates generally to telecommunications.

2. Description of the Background Art

A telephone conferencing service may be provided conventionally through “conferencing centers” provided as a service by local and long distance telephone companies. A list of telephone numbers of the conferees and the date and time at which the conference is to begin is supplied to a conference center operator who performs the dialing operations to bring the conferees simultaneously on line to initiate the conference. This technique is limited by the necessity of setting up a relatively inflexible forum in which all participants must be designated in advance, and the inclusion and reliance upon outside telephone company personnel to implement the conference.

A telephone conferencing service may also be provided based on enterprise equipment. Such a service may be implemented on an applications server at the enterprise.

Unfortunately, prior automatic conferencing services can have reliability and availability issues. For example, for an automatic conferencing service running on an application server at an enterprise, when the application server goes down, then the automatic conferencing service in unavailable. It is desirable to increase the robustness and availability of automatic conferencing services.

### SUMMARY

One embodiment of the invention relates to an apparatus for an automatic conferencing service. The apparatus includes at least a service logic execution environment in a telecommunications service network, and an automatic conferencing service running in the service logic execution environment.

Another embodiment of the invention relates to a method of scheduling an automatic conference. A conference request, including conference information specified by a user, is received by an automatic conferencing service running in a service logic execution environment within a telecommunications network. The automatic conferencing service registers the conference and sends notification to attendees of the conference.

### BRIEF DESCRIPTION OF THE DRAWINGS

FIG. 1 is a diagram depicting a system for a high-availability automatic conferencing service in accordance with an embodiment of the invention.

FIG. 2 is a diagram depicting select software components of a high-availability automatic conferencing service in accordance with an embodiment of the invention.

FIG. 3 is a diagram depicting an exemplary process of scheduling an automatic conference in accordance with an embodiment of the invention.

FIG. 4 shows an example user interface to enter information for a new conference.

FIG. 5 shows an example user interface to enter information for each conference attendee.

### DETAILED DESCRIPTION

I. System

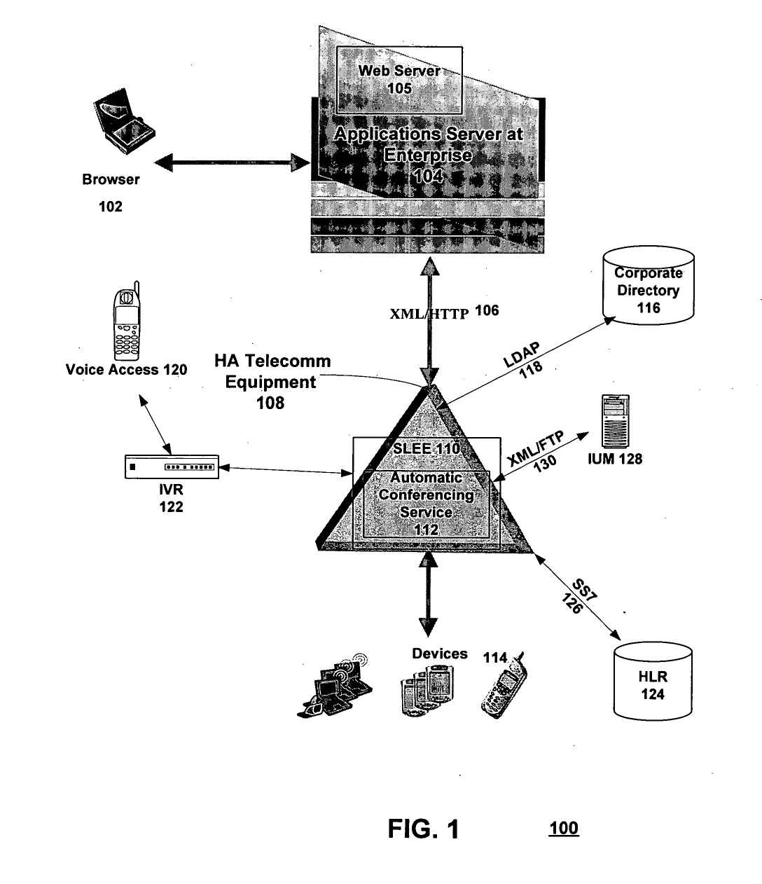

FIG. 1 is a diagram depicting a system 100 for a high-availability (HA) automatic conferencing service in accordance with an embodiment of the invention. To provide a higher-level of availability and to provide more direct access to functions in the telecommunications service network, the system 100 is advantageously configured with an automatic conferencing service 112 running in a service logic execution environment (SLEE) 110 on high-availability (HA) telecommunications equipment 108 within a telecommunications service network. In one implementation, the SLEE 110 may comprise an OpenCall Service Controller (OCSC) running on an HP-UX operating system.

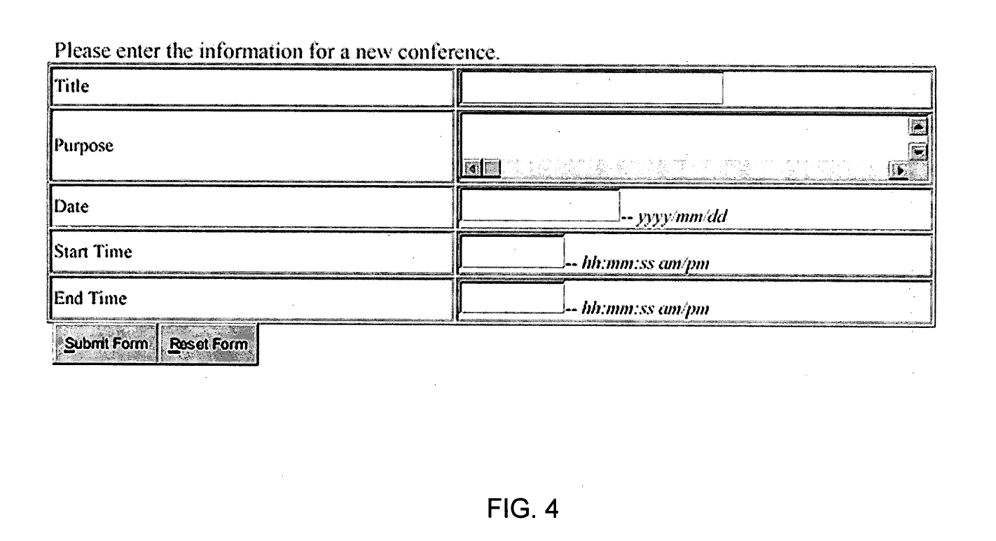

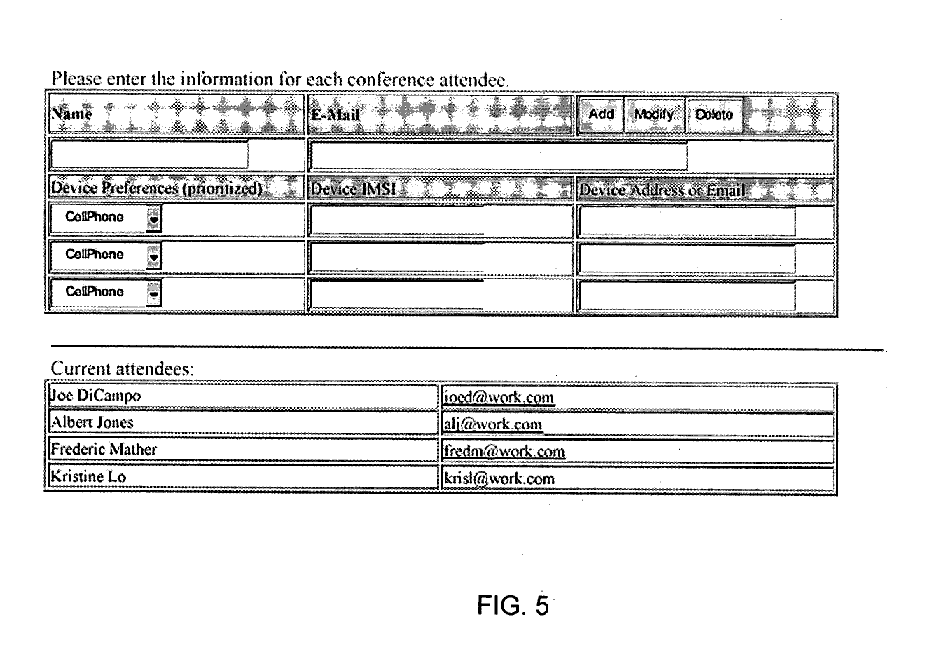

A conference organizer person may use a web browser 102 device to access the automatic conferencing service 112 so as to set up a teleconference. The browser 102 may access the service 112 by way of an automatic conferencing user interface (UI) to a web server 105 running on an applications server 104 of a corporate enterprise. The web server 104 may utilize an extensible markup language/hyper text transfer protocol (XML/HTTP) interface 106 to communicate with the automatic conferencing service 112. An example user interface to enter information for a new conference is shown in FIG. 4. An example user interface to enter information for each conference attendee is shown in FIG. 5.

In addition to the web-based access, the system 100 may be configured to include other access channels. For example, the automatic conferencing service 112 may be accessed by a conference organizer using a telephone or other voice access device 120. The telephone may access the service 112 by way of an interactive voice response (IVR) 122 interface.

The automatic conferencing software 112 may communicate with conference attendees using various types of communication devices 114. The devices 114 may include telephones, cell phones, wireless personal digital assistants (PDAs), computers with wired or wireless connections, and other communication devices. For example, notifications or reminders to the attendees may be communicated prior to the meeting and during the meeting for absent attendees.

Information regarding attendees, including their preference profiles, may be provided from a corporate or enterprise directory 116. The directory 116 may be accessed, for example, by way of a Lightweight Directory Access Protocol (LDAP) interface 118. LDAP is an Internet protocol that programs (for example, email programs) used to look up contact information from a server.

Online status information regarding attendees of a conference may be obtained by the automatic conferencing software 112 using lookups to a home location register (HLR) database 124. An SS7 (signaling system 7) interface 126 may be used for these HLR communications.

Billing information may be processed by an Internet Usage Manager (IUM) 128. The billing information may be communicated to the IUM 128 by way of an XML/FTP interface 130. FTP refers to file transfer protocol.

II. Software Modules

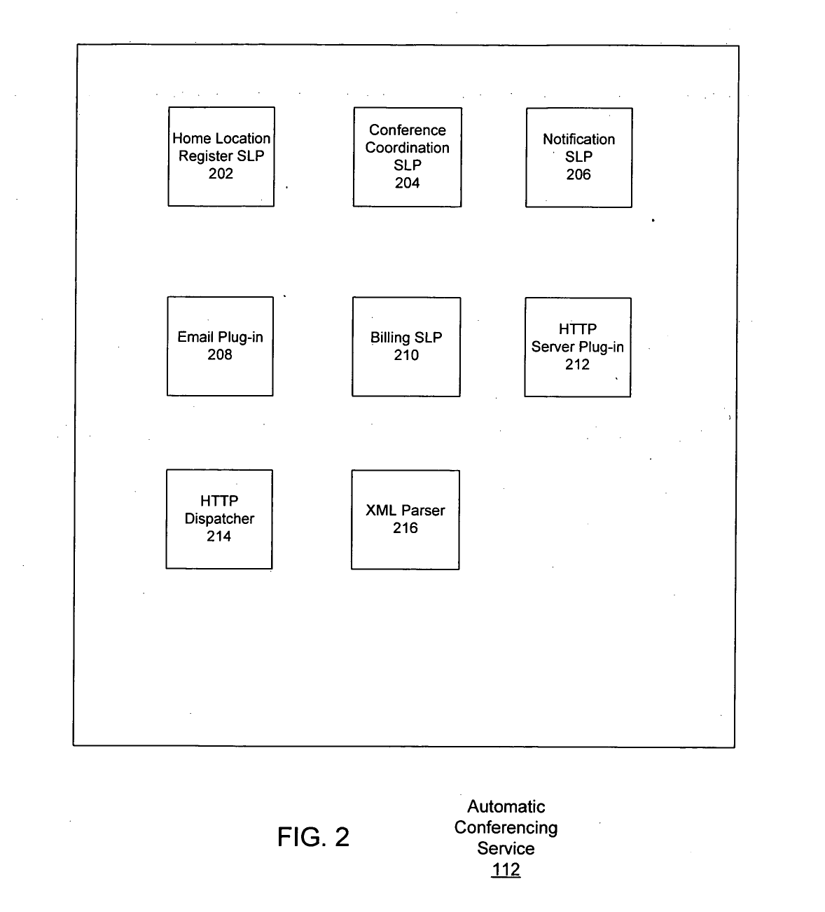

FIG. 2 is a diagram depicting select software components or modules of a high-availability automatic conferencing service 112 in accordance with an embodiment of the invention. The components shown include a Home Location Register (HLR) Database Lookup service logic program (SLP) 202, a Conference Coordinator SLP (also called the Automatic Conferencing SLP or AC SLP) 204, a Notification SLP 206, an Email Plug-in 208, a Billing SLP 210, an HTTP Server Plug-in 212, an HTTP Dispatcher 214, and an XML Parser 216. These modules and their operations and interactions are discussed in detail below.

HTTP Server Plug-In

In an embodiment, the HTTP Server Plug-in 212 is configured to receive XML messages in HTTP requests via an HTTP connection 106 and forward them via a plug-in channel to the HTTP Dispatcher SLP 214. The HTTP Server Plug-in 212 is also configured to receive XML response messages back from the HTTP Dispatcher SLP 214 and forwards them back to the same HTTP connection 106.

The HTTP Server Plug-in 212 may use an embedded web server to listen for HTTP connection requests. If the plug-in 212 accepts a connection, the embedded web server creates an HTTP Client object (HttpClient) to process the requests on that connection. Over time, multiple HTTP connections may access the same conference managed by a particular Conference Coordination SLP 204 instance that is active in the SLEE. For example, a conference may be set up via one HTTP connection, and later triggered via another HTTP connection, and then cancelled via yet another HTTP connection. However, multiple open HTTP connections may be prevented from accessing the same conference simultaneously such that only one HTTP connection can access a particular conference at a time. The HTTP Server Plug-in 212 may also maintain a map of conference IDs and PLUGIN sessions. It can therefore route requests for active conferences via the appropriate PLUGIN session, and route a request for a new conference by creating a new PLUGIN session to the HTTP Dispatcher 214.

The HTTP Server Plug-in 212 may start up when a UNIX-based service controller platform is started and may remain enabled while the platform is running. (The service controller platform may comprise, for example, an Open Source Service Controller (OCSC) platform or other similar platform.)

In an embodiment, the HTTP Server Plug-in 212 may be configured to perform the following procedural operations.
After the platform starts, the HTTP Server Plug-in 212 waits for HTTP connection requests.
If a connection is accepted, the HTTP Server Plug-in 212 creates a HttpClient object, implemented as a HTTP Plug-in Client object (HttpPiClientImpl), to process the requests on that connection.
The HttpClient receives an HTTP request from the Automatic Conferencing GUI containing a “Setup conference” document.
The HTTP Server Plug-in 212 builds a PLUGIN message with an XML message ID and that contains the “Setup conference” document.
The HTTP Server Plug-in 212 creates a new PLUGIN session and sends the PLUGIN message to the HTTP Dispatcher.
The HTTP Server Plug-in 212 maps the client with a conference ID of “Unknown” in its internal client table. This table can be checked to prevent subsequent “Setup conference” requests from being processed simultaneously until the “In progress” response with unique conference ID is received.
The HTTP Server Plug-in 212 then waits for incoming HTTP messages or PLUGIN messages.
If the HTTP Server Plug-in 212 receives another “Setup conference” request, it checks the client table to see that there already is an “Unknown” entry and rejects the request with an HTTP error response.
When The HTTP Server Plug-in 212 receives the “In progress” document from the AC SLP 204 via a PLUGIN session, it parses the document to determine the unique conference ID.
The HTTP Server Plug-in 212 removes the “Unknown” client mapping from the internal client table and maps that client with the specified conference ID in the client table. The HTTP Server Plug-in 212 also stores the conference ID internally in the HttpPiClientImpl as the current conference ID.
The HTTP Server Plug-in 212 maps the PLUGIN session with the specified conference ID and a requestStatus of InProgress in the internal session table.
The HTTP Server Plug-in 212 forwards the “In progress” document in a HTTP message to the proper HTTP connection.
The HTTP Server Plug-in 212 again waits for incoming HTTP messages or PLUGIN messages.
Whenever the HTTP Server Plug-in 212 receives a HTTP message with a conference ID, it looks up the conference ID in the client table. If the ID is in the table, it verifies the current HttpClient, not a different HttpClient, handles the HTTP message. If the ID is not in the table, the HTTP Server Plug-in 212 adds the conference ID and HttpClient to the client table as the current HttpClient for that conference.
Whenever the HTTP Server Plug-in 212 receives a “Checking online devices” response from the AC SLP 204, it forwards the response in a HTTP message to the proper HTTP connection.
When the HTTP Server Plug-in 212 receives a “Notifications sent” response from the AC SLP 204, it forwards the response to the proper HTTP connection, and sets the requestStatus to Done in the session table.
If the HTTP Server Plug-in 212 receives an HTTP message with a “Trigger request”, it looks up the conference ID in the session table. If its requestStatus is InProgress, it rejects the request with an HTTP error response. If its requestStatus is Done, it changes the requestStatus to InProgress and forwards the “Trigger request” via the proper PLUGIN session.
If the HTTP Server Plug-in 212 receives an HTTP message with a “Status request”, it looks up the conference ID in the session table and forwards the “Trigger request” via the proper PLUGIN session.
If the HTTP Server Plug-in 212 receives a HTTP message with a “Cancel request”, it looks up the conference ID in the session table, and forwards the “Cancel request” via the proper PLUGIN session. It then deletes the conference ID rows from the session and client tables, changes the current conference ID for the HttpPiClientImpl to “None”, and closes the PLUGIN session for that conference.
If the HTTP Server Plug-in 212 receives a “Conference started” PLUGIN message from the AC SLP 204, it knows the AC SLP has completed successfully and exited. It also deletes the conference ID rows from the session and client tables, changes the current conference ID for the HttpPiClientImpl to “None”, and closes the PLUGIN session for that conference.
When the AC GUI browser closes the HTTP connection, the HttpClient terminates. The HttpPiClientImpl destructor is called, which removes any entry from the client table for the current conference ID for that client. The conference may still be active in the session table, allowing another HttpClient to access the conference at a later time for a trigger, status, or cancel requests.
   Each HttpPiClientImpl stores internally the conference ID it is currently responsible for. The HTTP Server Plug-in 212 may be configured to use an internal session table to map a conference ID to a PLUGIN session. The HTTP Server Plug-in 212 may also be configured to keep track of whether a conference has a request in-progress or done. The HTTP Server Plug-in 212 may further be configured to use an additional internal client table to map a conference ID to the current HttpClient that is processing requests and responses for that conference.

HTTP Dispatcher SLP

In accordance with an embodiment, the HTTP Dispatcher SLP 214 may comprise a multi-service SLP and can be used for more than just the Automatic Conferencing Service. The HTTP Dispatcher SLP 214 receives initial request messages coming into the SLEE via the HTTP Server Plug-in 212. The HTTP Dispatcher SLP 214 determines which SLP is responsible for processing the request and forwards the message. The HTTP Dispatcher SLP 214 only handles the initial request; subsequent requests and responses are handled directly by the responsible SLP.

The HTTP Dispatcher 214 may start-up when, for example, a UNIX-based service controller platform is started and may remain enabled while the platform is running.

In an embodiment, the HTTP Dispatcher SLP 214 may be configured to perform the following procedural operations.
After the platform starts, the HTTP Dispatcher SLP 214 waits for incoming messages from the PLUGIN channel.
The service controller platform creates an HTTP Dispatcher SLP 214 instance to handle the first message that arrives on a particular OCSC PLUGIN session.
The Dispatcher 214 instance receives the incoming message and checks the PLUGIN message ID to determine what type of message it is.
The Dispatcher 214 instance looks up the message ID in a table in the SLEE database to determine which SLP should process the message.
If the message has an XML message ID (as defined in the xml.ddl file), the database lookup will determine that the Dispatcher 214 should send the message to the AC SLP 204.
The Dispatcher 214 instance creates an AC SLP 204 instance and outputs the PLUGIN message to it.
The Dispatcher 214 instance terminates.
   In an implementation, the SLEE database may be used to configure the SLP that processes the incoming PLUGIN message, based on its message ID.

Conference Coordination SLP

The Conference Coordination or Automatic Conference (AC) SLP 204 performs the coordination and processing needed to provide the automatic conferencing service. The AC SLP 204 receives, processes, and responds to the conference requests, keeping track of the information for all outstanding conferences.

When the HTTP Dispatcher 214 receives a “Setup conference” request, it creates an instance of the AC SLP 204 and forwards the request to be processed. The AC SLP 204 instance terminates after the conference has been executed, or cancelled.

In accordance with this embodiment, there is a one-to-one relationship between each conference and a corresponding AC SLP 204 instance. The number of outstanding conferences is limited by the number of AC SLP 204 instances that can be active simultaneously.

In an alternate embodiment, the one-to-one feature may be changed by providing an additional Conference Dispatcher SLP (not shown). Such a Conference Dispatcher SLP would coordinate the outstanding conferences and the active AC SLP 204 instances, tracking them using the unique conference ID's. A particular AC SLP 204 instance may be configured to do the initial conference setup, then it would terminate. The Conference Dispatcher SLP could create a new AC SLP instance to handle any subsequent conference status, trigger, or cancellation messages.

The AC SLP 204 communicates with other SLPs via SLEE signals containing XML documents. The AC SLP 204 also writes conference information into SLEE database tables that can be read and updated by the other SLPs as appropriate.

The AC SLP 204 also communicates with the HTTP Server Plug-in 212 by sending the same XML documents via an OCSC PLUGIN channel. After receiving the first “Setup conference” XML document from the HTTP Dispatcher, the AC SLP 204 instance communicates directly with the HTTP Server Plug-in 212 from then on. Each conference, with its own unique conference ID, is managed by a separate AC SLP 204 instance. The AC SLP 204 instance communicates with the corresponding AC UI instance via the HTTP Server Plug-in 212 using a dedicated Plug-in session of the PLUGIN channel interface. That PLUGIN session may stay open for the lifetime of the conference.

With the possible Conference Dispatcher enhancement mentioned above, the Conference Dispatcher would also coordinate the correlation of unique conference IDs and PLUGIN sessions. A PLUGIN session would not be required to stay open for the lifetime of the conference, but sessions could be closed as SLP instances terminate, and reopened as needed for subsequent messages.

In an embodiment, the AC SLP 204 may be configured to perform the following procedural operations.
An AC SLP 204 instance receives a “Setup conference” document from the HTTP Dispatcher 214 via an output PLUGIN message.
From the PLUGIN message, the AC SLP 204 instance determines the Plug-in session it will use for subsequent communication with AC UI via the HTTP Server Plug-in 212.
The AC SLP 204 instance uses the XML Parser 216 SNI to parse the document as appropriate.
The AC SLP 204 instance generates a unique conference ID.
The AC SLP 204 instance sends the unique conference ID in a “In progress” response back via the HTTP Server Plug-in 212. It saves the response as the current XML document for that conference. For persistence, it also stores the conference data in the SLEE database keyed by the conference ID.
The AC SLP 204 instance sets up a timer so it can be signaled at a configurable interval (default 5 minutes in an embodiment) before the conference is scheduled to start.
The AC SLP 204 instance creates a Notification SLP instance and signals it with the document to send the appropriate notifications.
The AC SLP 204 instance then waits for incoming signals.
When the AC SLP 204 instance receives a “Checking online devices” or “Notifications sent” response from the Notification SLP 206, it saves that as the current XML document for that conference, saves the conference data in the SLEE database, and sends the response via the HTTP Server Plug-in 212.
If the AC SLP 204 instance receives a “Status request” from the HTTP Server Plug-in 212, it responds with the current XML document.
If the AC SLP 204 instance receives a “Cancel request” from the HTTP Server Plug-in 212, it cancels the timer, forwards the request to the Notification SLP 206 if it is active, deletes the conference data from the SLEE database, responds with a “Request cancelled”, and exits.
When the Notification SLP 206 signals the AC SLP 204 instance that the attendees have been notified, the AC SLP 204 instance signals the Billing SLP 210 with the current XML document to generate the appropriate billing records.
If the AC SLP 204 instance receives a “Trigger notifications” request, it again creates a Notification SLP 206 instance and signals it with the current XML document to again send the appropriate notifications.
When the timer pops, the AC SLP 204 instance again creates a Notification SLP 206 instance and signals it with the current XML document to again send the appropriate notifications. It then creates a new timer so it can be signaled when the conference is starting.
When the second timer pops, the AC SLP 204 again creates a Notification SLP 206 instance and signals it with the current XML document to again send the appropriate notifications.
When the Notification SLP 206 signals the AC SLP 204 that the attendees have been notified that the conference has started, the AC SLP 204 is completed successfully. It sends a “Conference started” message with the conference ID to the HTTP Server Plug-in 212. It then deletes the conference data from the SLEE database, and exits.
   The current conference information may be maintained as an XML document kept in a buffer local to the SLP instance. The current conference information may also be kept in the SLEE database so that it can easily be shared with the Notification SLP 206 and the Billing SLP 210. The information may be kept in multiple tables.

XML Parser

The XML Parser 216 may utilize a service logic execution language (SLEL) interface to provide XML parsing functions to SLP programs. The interface may specify wrapper functions that use an “expat” shared library to perform the actual parsing.

Notification SLP

The Notification SLP 206 sends conference announcement messages to the appropriate devices of the conference attendees.

An AC SLP 204 instance creates a Notification SLP 206 instance when the AC SLP 204 desires that conference announcements be sent out. The Notification SLP 206 instance terminates after it signals the AC SLP 204 that all notifications have been successfully sent.

The Notification SLP 206 communicates with other SLPs via SLEE signals containing XML documents. The Notification SLP 206 also reads conference information from the SLEE database tables created by the AC SLP 204. In particular, it also reads the device online status that is updated by the HLR SLP 202.

The Notification SLP 206 also communicates with the Email plug-in 208 with a service controller PLUGIN messages via a service controller PLUGIN channel. The Email plug-in 208 is asynchronous, so it does not respond to the PLUGIN messages and assumes the email messages were sent correctly.

In an embodiment, the Notification SLP 206 instance may be configured to perform the following procedural operations.
The Notification SLP 206 instance receives a request document from the AC SLP 204 for a current conference request. It saves the request as the current XML document for this conference.
The Notification SLP 206 instance creates an HLR SLP 202 instance and signals it with the document to check the online status of the attendees.
The Notification SLP 206 instance then waits for incoming signals.
If at this time the Notification SLP 206 instance receives a “Cancel request” from the AC SLP 204, it forwards the request to the HLR SLP 202 if it is active, and exits.
Whenever the Notification SLP 206 instance receives a “Checking online devices” response from the HLR SLP 202, it saves that as the current XML document for that conference, and sends the response back to the AC SLP 204.
When the Notification SLP 206 instance receives the “Done checking devices” response from the HLR SLP 202, it saves that as the current XML document for that conference, and starts sending notifications to the subscribers.
The Notification SLP 206 instance reads the SLEE database as appropriate to get the conference information, subscriber information, and device information. This includes the online device status that was just updated by the HLR SLP 202.
The Notification SLP 206 instance processes each subscriber in the subscriber list.
For each subscriber, the Notification SLP instance searches for the first device 114 (listed in order of preference) that is online.
If the device 114 is a cell-phone (using SMS), the Notification SLP 206 instance puts together an email body with the conference title, start time, and end time. The conference purpose is not included to keep the SMS message short. It specifies an email address that is the address specified for the device.
If the device 114 is a laptop or PDA, the Notification SLP 206 instance puts together an email body with the conference title, purpose, start time, and end time. It specifies an email address that is the address specified for the device.
If the subscriber has no online devices 114, the Notification SLP 206 instance puts together an email body with the conference title, purpose, start time, and end time. It specifies an email address that is the subscriber's email address.
The Notification SLP 206 instance puts together a PLUGIN message containing the email message SLEL with the email address, email body, and an email subject of “Conference notification”.
For the first subscriber, the Notification SLP 206 instance creates PLUGIN session to send the PLUGIN message to the Email plug-in 208. It uses the same PLUGIN session to send PLUGIN messages for each of the subsequent subscribers.
After all the subscribers have been processed, the Notification SLP 206 instance updates the XML document to have a conference status of “Notifications sent”, and sends it as a response to the AC SLP 204.
The Notification SLP 206 instance then puts together a PLUGIN message with a message ID of email_finished, and sends the message to the Email plug-in 208. It closes the plug-in session it used with the Email plug-in 208, and exits.
Also if the Notification SLP 206 instance receives a “Cancel request” from the AC SLP 204 while sending notifications, it sends the email_finished message to the Email plug-in, 208 closes the plug-in session and exists.
   The current conference information may be kept as an XML document in a buffer local to the Notification SLP 206 instance. As appropriate, the Notification SLP 206 can also access the database tables specified above for the AC SLP 204.

Home Location Register SLP

The Home Location Register (HLR) SLP 202 provides an HLR database lookup to determine the online status of the devices of attendees. In an implementation, the HLR SLP 202 may be configured to send HLR requests via an HLR Plug-in to a CORBA (Common Object Request Broker Architecture) interface of an HLR database to determine the online status of devices.

The Notification SLP 206 creates a HLR SLP 202 instance when it needs device status information. The HLR SLP 202 instance terminates after it signals the Notification SLP 206 with the “Done checking devices” message.

The HLR SLP 202 communicates with other SLPs via SLEE signals containing XML documents. It also updates the device status in a device table created by the AC SLP 204 in the SLEE database.

In an embodiment, the HLR SLP 202 instance may be configured to perform the following procedural operations.
The HLR SLP 202 instance receives a request document from the Notification SLP 206 for a current conference request. It saves the request as the current XML document for this conference.
The HLR SLP 202 instance reads the conference data from the AC SLP 204 database tables as appropriate.
The HLR SLP 202 instance updates the conference status of the document to be “Checking online devices” and saves the document as the current XML document in the SLP.
The HLR SLP 202 instance processes each subscriber in the subscriber list.
For each subscriber, the HLR SLP 202 instance processes each device 114 (listed in order of preference), until it finds a device 114 (if any) that is online.
For each device, the HLR SLP 202 instance looks up the device 114 IMSI (International Mobile Subscriber Identity) code in the IMSI table in the SLEE database to determine if the device is “Offline” or “Online.” If the IMSI code is not found in the SLEE database, the device 114 is specified to be “Offline.”
The HLR SLP 202 instance updates the status of the device 114 in the current XML document and in the device table created by the AC SLP 204 in the SLEE database.
When the HLR SLP 202 instance finds a subscriber's device 114 that is online, or that none of the subscriber's device 114 are online, it sends the current XML document as a “Checking online devices” response to the Notification SLP 206.
After all subscribers have been processed, the HLR SLP 202 instance updates the current XML document to have a conference status of “Done checking devices”, sends it as a response to the Notification SLP 206, and exits.
If the HLR SLP 202 instance receives a “Cancel request” from the Notification SLP 206, it exits.
   The current conference information may comprise a XML document kept in a buffer local to the HLR SLP 202 instance. The HLR SLP 202 can also access the database tables specified above for the AC SLP 204. The SLEE database may be used to configure the online status of the devices, keyed on the device IMSI number.

Email Plug-In

The Email Plug-in 208 sends an email message with a specified subject and body to specified addresses. The Email Plug-in 208 may be configured to be automatically enabled whenever the service controller platform is started. The Email Plug-in 208 may remain enabled and waiting for incoming messages until the service controller platform is shutdown.

The Notification SLP 206 may be configured to communicate with the Email plug-in 208 with service controller PLUGIN messages via a service controller PLUGIN channel. The PLUGIN messages may contain SLEL data. The Email plug-in 208 is asynchronous, so it does not respond to the PLUGIN messages and assumes the email messages were sent correctly.

In an embodiment, the Email Plug-in 208 may be configured to perform the following procedural operations.
After the platform starts, the Email Plug-in 208 waits for incoming PLUGIN message from the Notification SLP 206.
When the Email Plug-in 208 receives a PLUGIN message on a new or existing PLUGIN session, it checks the message ID to ensure it is an email message ID.
The Email Plug-in 208 forks and executes a separate process to send the email message with the specified email subject and body to the email addresses. This ensures that no actual file system access is done in the plug-in process itself.
If the PLUGIN message ID is email_finished, then the Email Plug-in 208 knows the Notification SLP 206 has closed the PLUGIN session from the SLP side. The Email Plug-in 208 closes the session from the plug-in side, and waits for additional incoming messages from other SLPs.

Billing SLP

The Billing SLP 210 may be configured so as to receive an XML conferencing message from the AC SLP 204. From that message, the Billing SLP 210 may generate an XML file including appropriate Internet Protocol Detail Records (IPDR) for billing. This file with the IPDR billing records may be detected via an XML/FTP interface 130 and processed by an Internet Usage Manager (IUM) 128.

III. Exemplary Process

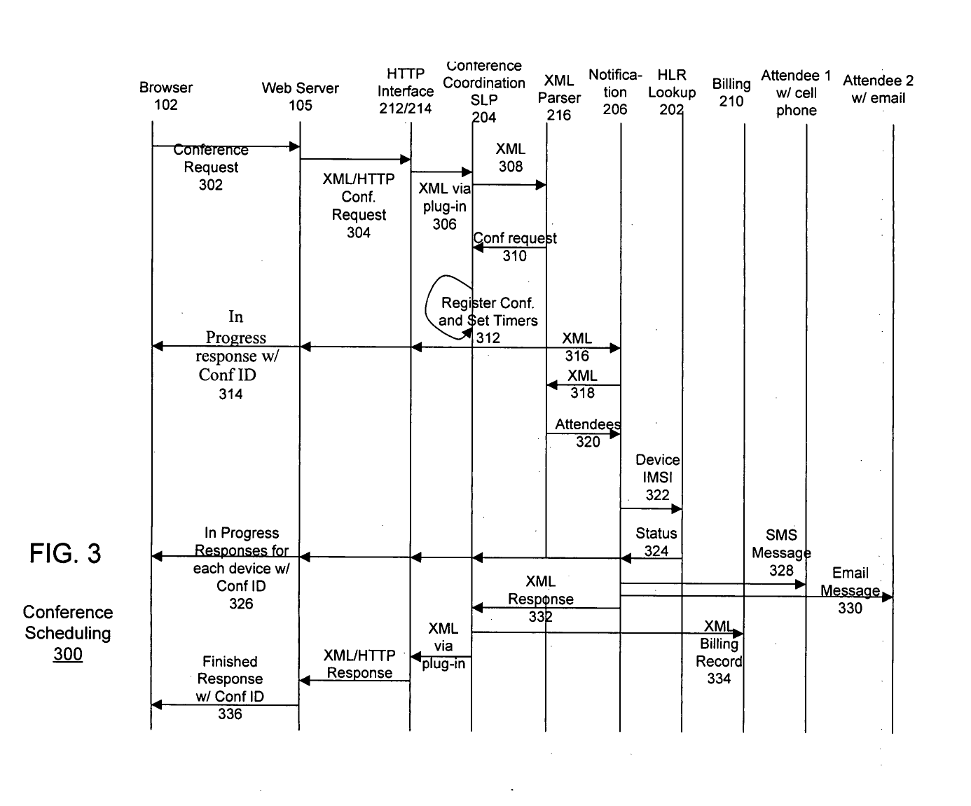

FIG. 3 is a diagram depicting an exemplary process 300 of scheduling an automatic conference in accordance with an embodiment of the invention. The process 300 begins when a conference coordinator person (i.e. a user) utilizes a browser 102 to access a web page from a web server 105. The web page provides access to the automatic conferencing service. Using the web page mechanism, the coordinator, in step 302, sends a request to schedule a conference. In an implementation, the coordinator provides the name, purpose, time and duration of the requested conference, the names of conference attendees, and their device profiles. This conference request, in step 304, is communicated from the web server 105 via the XML/HTTP interface 106 to the pertinent high-availability telecommunications equipment 108. In addition, authorization of the user may be confirmed. The HTTP Server Plug-in 212 receives the request and, in step 306, sends the XML message to the HTTP Dispatcher 214, which provides the XML message to the Conference Coordinator SLP 204. The Conference Coordination SLP 204, in step 308, provides the XML message to the XML Parser 216. After parsing the message, the XML Parser 216, in step 310, returns the conference request information therein to the Conference Coordination SLP 204.

The Conference Coordination SLP 204, in step 312, registers the conference with a unique conference identifier (ID). Pertinent timers for the conference are also set by the Conference Coordination SLP 204.

A notification is returned, in step 314, by the Conference Coordination SLP 204 via the web interface to the conference coordinator person that the scheduling is in progress. The notification includes the conference ID assigned to this request.

The Conference Coordination SLP 204 proceeds to coordinate the notification to the conference attendees of the conference information along with the necessary contact information for them to be able to join the conference. This may be accomplished, for example, by the following.

The Conference Coordination SLP 204 may create an instance of the Notification SLP 206 and, in step 316, signals it with the XML document for that conference. The Notification SLP 206 may extract the attendee information by sending, in step 318, the XML document to the XML Parser 216 so that the XML Parser 216 can return, in step 320, the attendee information therein.

The Notification SLP 206 may then create an instance of the HLR SLP 202. The Notification SLP 206 may provide, in step 322, the device IMSI data for the attendees to the HLR SLP 202. The HLR SLP 202 looks up the current online status of the attendees, and returns, in step 324, the status information to the Notification SLP 206. The status information is returned from the Notification SLP 206 to the Conference Coordination SLP 204 which may return, in step 326, another in-progress response (“Checking online devices”) including this status information via the web interface to the conference coordinator person.

Based on the status information, the Notification SLP 206 may also be instructed to send appropriate notice messages to the attendees. The notice messages may take the form of, for example, an SMS message that is sent, in step 328, to an attendee with a cell phone, and an email message that is sent, in step 330, to another attendee with email.

Thereafter, an XML response indicating that the notices were sent may be returned, in step 332, from the Notification SLP 206 to the Conference Coordinator SLP 204. Based upon that, the Conference Coordinator SLP 204 may send, in step 336, a finished or “Notifications sent” response for that conference ID via the HTTP Interface 212/214, to the Web Server 105, to the Browser 102, and finally to the conference coordinator person. In addition, the Conference Coordinator SLP 204 may signal, in step 334, the Billing SLP 210 with the current XML document to generate the appropriate billing records.

As mentioned in the above discussion of FIG. 1, FIG. 4 shows an example user interface to enter information for a new conference, and FIG. 5 shows an example user interface to enter information for each conference attendee.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. An apparatus for an automatic conferencing service, the apparatus comprising:
a service logic execution environment in a telecommunications service network; and
automatic conferencing service running in the service logic execution environment.

2. The apparatus of claim 1, wherein modules of the automatic conferencing service include a conference coordination service logic program.

3. The apparatus of claim 2, wherein the automatic conferencing service modules further include an HTTP interface.

4. The apparatus of claim 3, wherein the HTTP interface comprises an HTTP server plug-in module and an HTTP dispatcher module.

5. The apparatus of claim 2, wherein the automatic conferencing service modules further include an extensible markup language parser.

6. The apparatus of claim 2, wherein the automatic conferencing service modules further include a notification service logic program.

7. The apparatus of claim 2, wherein the automatic conferencing service modules further include a home location register service logic program.

8. The apparatus of claim 2, wherein the automatic conferencing service modules further include a billing service logic program.

9. A method of scheduling an automatic conference, the method comprising:
reception of a conference request, including conference information specified by a user, by an automatic conferencing service running in a service logic execution environment within a telecommunications network;
registration of the conference by the automatic conferencing service; and
notification of attendees of the conference by the automatic conferencing service.

10. The method of claim 9, wherein a user specifies the conference information by way of a web page hosted by web server software on an applications server coupled to the telecommunication network.

11. The method of claim 10, wherein the conference information includes time and attendee information, and wherein extensible markup language is used to communicate the conference information from the applications server to the automatic conferencing service.

12. The method of claim 9, wherein a user specifies the conference information using a phone to access an interactive voice response interface to the automatic conferencing service.

13. The method of claim 9 further comprising setting timers for the conference by the automatic conferencing service.

14. The method of claim 9 further comprising determination of an online status of a communication device of an attendee.

15. The method of claim 14, wherein the online status determination is accomplished by way of a lookup to a home location register database.

16. The method of claim 9, wherein an attendee is notified by way of electronic mail.

17. The method of claim 9, wherein an attendee is notified by way of an SMS message.

18. The method of claim 9, wherein an attendee is notified by way of an instant message.

19. The method of claim 9 further comprising accessing a directory by the automatic conferencing service to obtain a preference profile for an attendee.

20. The method of claim 19, wherein the directory is accessed using a lightweight directory access protocol interface.

21. A telecommunications system configured to schedule an automatic conference, the system comprising:
means for receiving a conference request, including conference information specified by a user, by an automatic conferencing service running in a service logic execution environment within a telecommunications network; and
means for notifying attendees of the conference by the automatic conferencing service.
